(19) United States
(12) Patent Application Publication
(10) Pub. No.: US 2016/0077474 A1
(43) Pub. Date: Mar. 17, 2016

(54) IMAGE FORMING APPARATUS, WHICH INCLUDES A FIXING DEVICE CAPABLE OF FIXING ERASABLE TONER

(71) Applicants: KABUSHIKI KAISHA TOSHIBA, Tokyo (JP); TOSHIBA TEC KABUSHIKI KAISHA, Tokyo (JP)

(72) Inventors: Takaho Watanabe, Mishima (JP); Satoshi Kinouchi, Tokyo (JP); Tokihiko Ise, Shizuoka (JP); Ryota Saeki, Mishima (JP)

(21) Appl. No.: 14/483,367

(22) Filed: Sep. 11, 2014

(51) Int. Cl. G03G 15/20

(52) U.S. Cl. CPC G03G 15/2039; G03G 15/2053

(57) ABSTRACT

An image forming apparatus comprises a fixing device configured to fix an image formed by an image forming section on an image receiving medium. The fixing device includes a heating roller, an auxiliary roller arranged at an entering side of the image receiving medium, and a fixing belt which is stretched by a plurality of rollers including the auxiliary roller and cyclically rotates in a state of being contacted with part of the outer periphery of the heating roller; wherein the auxiliary roller is arranged at a position which is closer to the entering side of the image receiving medium than a fixing nip section between the heating roller and the fixing belt and is at a preset distance away from the fixing nip section. The image forming apparatus further comprises an inlet guide configured closer to the entering side of the image receiving medium than the auxiliary roller.

### FIELD

Embodiments described herein relate to an image forming apparatus capable of forming an image with erasable coloring agent and erasing an image formed on an image receiving medium.

### BACKGROUND

Conventionally, in an electrophotographic type image forming apparatus, paper on which toner is adhered is conveyed to a fixing device to fix the toner on the paper by heating and pressing. The fixing device nips and conveys the image receiving medium (for example, paper) between a heating roller and a pressing roller to fix the toner on the paper. The paper is guided to a nip section between the heating roller and the pressing roller by a guide member.

On the other hand, in a case where an image is formed on the paper with erasable coloring agent, the image formed on the paper can be erased by heating the paper at a temperature higher than the fixing temperature. However, in a case of passing paper through the fixing device to erase the images of the paper both sides of which are printed, though the image printed on one side can be erased by sufficient heat, the image printed on the other side cannot be erased completely due to insufficient heat, which leads to erasing residual.

### BRIEF DESCRIPTION OF THE DRAWINGS

FIG. 1 is a constitution diagram illustrating an image forming apparatus according to one embodiment;

FIG. 2 is a constitution diagram illustrating the operations of a fixing device according to the embodiment;

FIG. 3 is a front view illustrating the fixing device and mechanisms around the fixing device according to the embodiment;

FIG. 4 is a perspective view illustrating the fixing device and mechanisms around the fixing device according to the embodiment;

FIG. 5 is an illustration diagram illustrating the position relation between an inlet guide and an auxiliary roller according to the embodiment;

FIG. 6 is a perspective view illustrating a state in which the inlet guide is mounted on a lower cover according to the embodiment; and

FIG. 7 is a block diagram illustrating a control system of the image forming apparatus according to the embodiment.

### DETAILED DESCRIPTION

In accordance with one embodiment, an image forming apparatus comprising:

a fixing device, which fixes an image formed by an image forming section on an image receiving medium, configured to include a heating roller, an auxiliary roller arranged at an entering side of the image receiving medium, and a fixing belt which is stretched by a plurality of rollers including the auxiliary roller and cyclically rotates in a state of being contacted with part of the outer periphery of the heating roller, wherein the auxiliary roller is arranged at a position which is closer to the entering side of the image receiving medium than a fixing nip section between the heating roller and the fixing belt and is at a preset distance away from the fixing nip section; and

an inlet guide configured closer to the entering side of the image receiving medium than the auxiliary roller to guide the image receiving medium towards the fixing nip section.

Hereinafter, the image forming apparatus according to the embodiment is described in detail with reference to the accompanying drawings. In addition, the same components in each figure are applied with the same reference numerals.

### A First Embodiment

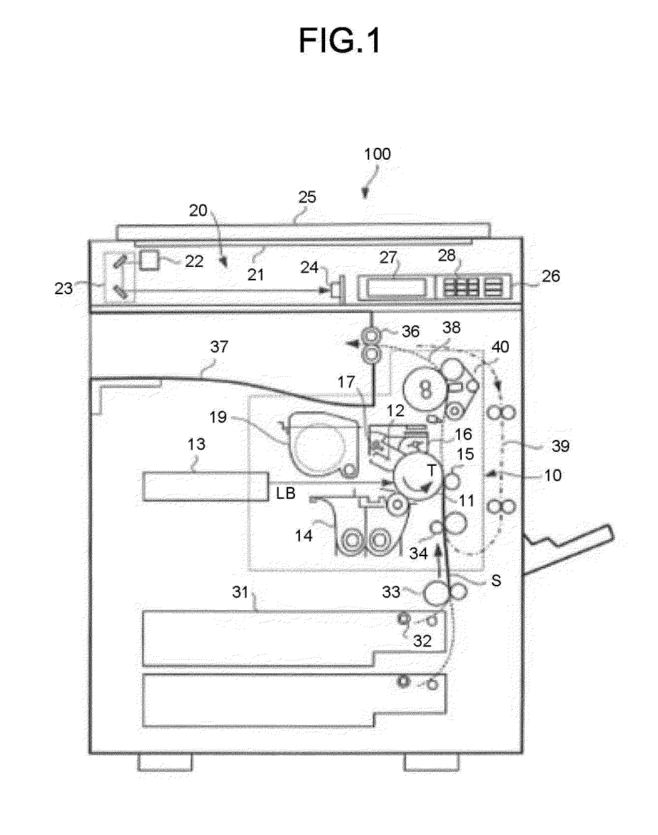

FIG. 1 is a constitution diagram illustrating the image forming apparatus according to the embodiment. In FIG. 1, an image forming apparatus 100 is, for example, an electrophotographic type copier. Though the image forming apparatus 100 may also be a printer, multi-function peripherals (MFP) and the like in addition to the copier, in the following description, the copier is exemplified.

The image forming apparatus (copier) 100 is provided with a printer section 10 at the center part thereof. The printer section 10 includes a rotatable photoconductive drum 11. The photoconductive drum 11 serving as an image carrier includes organic photo conductor at the outer periphery. If the photoconductive drum 11 is irradiated with light in a state in which given potential is applied to the photoconductive drum 11, the potential of an area irradiated with light changes and the change of potential is maintained for a given time as an electrostatic latent image.

An electrostatic charger 12, an exposure unit 13, a developer 14, a transfer roller 15, a drum cleaner 16 and a charge removing LED 17 are arranged around the photoconductive drum 11 along a rotation direction T of the photoconductive drum 11.

The electrostatic charger 12 charges the surface of the photoconductive drum 11 to a given potential. The exposure unit 13 exposes the photoconductive drum 11 by irradiating the photoconductive drum 11 with laser beam LB to form an electrostatic latent image on the surface of the photoconductive drum 11. The laser beam LB changes the strength of the light according to the concentration of the image and the like.

The developer 14 stores two-component developing agent including carrier and toner, and supplies the developing agent to the surface of the photoconductive drum 11 to develop the electrostatic latent image of the photoconductive drum 11. The electrostatic latent image on the surface of the photoconductive drum 11 is visualized to form a toner image. The transfer roller 15 constitutes a transfer device. The transfer roller 15 applies a given potential to a paper S serving as an image receiving medium to transfer the toner image on the photoconductive drum 11 to the paper S. The drum cleaner 16 removes and collects the toner and the like left on the surface of the photoconductive drum 11. The charge removing LED 17 removes the charge left on the photoconductive drum 11. Further, a fixing device 40 is arranged at the downstream side of the transfer roller 15. The fixing device 40 conveys the paper S while pressing and heating the paper S at a given temperature to fix the toner image on the paper S. The fixing device 40 is described in detail later.

Further, a developing agent cartridge 19 for storing toner and developing agent is arranged above the developer 14, and if the toner and the developing agent in the developer 14 are consumed, the developer 14 is replenished with toner and developing agent from the cartridge 19. The developing agent cartridge 19 can be exchanged.

On the other hand, a scanner section 20 is arranged above the image forming apparatus 100. The scanner section 20 includes a light source 22 for irradiating an original placed on an original placing table 21 with light, a reflecting mirror 23 for reflecting light reflected form the original and an image sensor 24 for receiving the light reflected from the reflecting mirror 23. Further, an original cover 25 is arranged to be capable of being opened and closed freely above the original placing table 21. An operation panel 26 is arranged nearby the scanner section 20. The operation panel 26 includes a touch panel type display section 27 and operation keys 28.

A paper feed cassette 31 is arranged at the lower portion of the image forming apparatus 100. A plurality of paper feed cassettes 31 are arranged according to the size of the paper. The paper S (image receiving medium) in the paper feed cassette 31 is guided to the transfer roller 15 by a pickup roller 32, an aligning roller 33 and a register roller 34. The pickup roller 32 picks up the paper S in the paper feed cassette 31 one by one and conveys the paper S to the aligning roller 33. To align the positions of the paper S and the toner image formed on the photoconductive drum 11, the aligning roller 33 rotates at given timing to convey the paper S to the transfer position. The paper S passing through the transfer roller 15 is conveyed through the fixing device 40 and discharged to the paper discharge tray 37 by the paper discharge roller 36.

In a case of simplex printing, the paper S is conveyed on a conveyance path 38 from the register roller 34 to the transfer roller 15, and then from the transfer roller 15 via the fixing device 40 to the paper discharge roller 36. Further, a reversal conveyance path 39 used in a case of carrying out duplex printing is arranged. When duplex printing is carried out, the paper S is conveyed from the paper discharge roller 36 towards the paper discharge tray 37 temporarily, and then switched back and conveyed to the reversal conveyance path 39. The reversal conveyance path 39 including a plurality of conveyance rollers reverses the paper S and guides the paper S to the register roller 34.

As stated above, the register roller 34, the transfer roller 15, the fixing device 40 and the paper discharge roller 36 convey the paper S to the printer section 10 and convey the paper on which an image is formed by the printer section 10 to the paper discharge tray 37.

During the image forming process, light is emitted from the light source 22 to the original on the original placing table 21, and the light reflected from the original enters the image sensor 24 through the reflecting mirror 23, in this way, the original image is read. The laser beam LB is output from the exposure unit 13 to the surface of the photoconductive drum 11 based on the information read by the image sensor 24 or image information supplied from an external device such as a PC (Personal Computer) and the like. The surface of the photoconductive drum 11 is negatively charged by the electrostatic charger 12, and the photoconductive drum 11 irradiated with the laser beam LB from the exposure unit 13 is exposed, in this way, an electrostatic latent image is formed on the surface of the photoconductive drum 11.

The electrostatic latent image formed on the photoconductive drum 11 is developed with toner by the developer 14 and becomes a visible image (toner image). Then if the paper S taken out from the paper feed cassette 31 is conveyed, the toner image on the photoconductive drum 11 is transferred to the paper S by the transfer roller 15. The paper S transferred with the toner image is conveyed to the fixing device 40 and heated and pressed by the fixing device 40 to fix the image on the paper S. The paper S on which the image is fixed is discharged to the paper discharge tray 37 through the paper discharge roller 36.

By the way, in a case of forming an image with erasable coloring agent (toner), the erasable toner is stored in the developer 14. The erasable toner causes a reversible color generation/erasing reaction, that is, the erasable toner is erased if heated to a temperature above a specified temperature, and generates color at a temperature lower than the specified temperature. The coloring agent used in the erasable toner may be any kind of coloring agent that can be erased when the temperature is raised by heating and can restore the color when the temperature is below the specified temperature. For example, leuco dye is generally used as well-known coloring agent, and the coloring agent is selected which is obtained by properly combining color developing agent, color erasing agent and discoloration temperature adjusting agent and the like and can be erased at a temperature above a certain temperature and can restore the color at a temperature below a certain temperature.

In a case where an image is formed with erasable toner, the paper S to which the toner image is transferred by the transfer roller 15 is conveyed to the fixing device 40. Then the paper S is heated while passing through the fixing device 40, in this way, the toner image is fixed on the paper S. Further, the fixing device 40 can heats the paper S at a temperature higher than the temperature used when fixing the toner image on the paper S to function as a color erasing device. That is, if the paper S on which an image is formed with erasable toner is conveyed to the fixing device 40 and the temperature of the fixing device 40 is set to a temperature above a specific temperature which is higher than a general fixing temperature, the image formed with the erasable toner is erased.

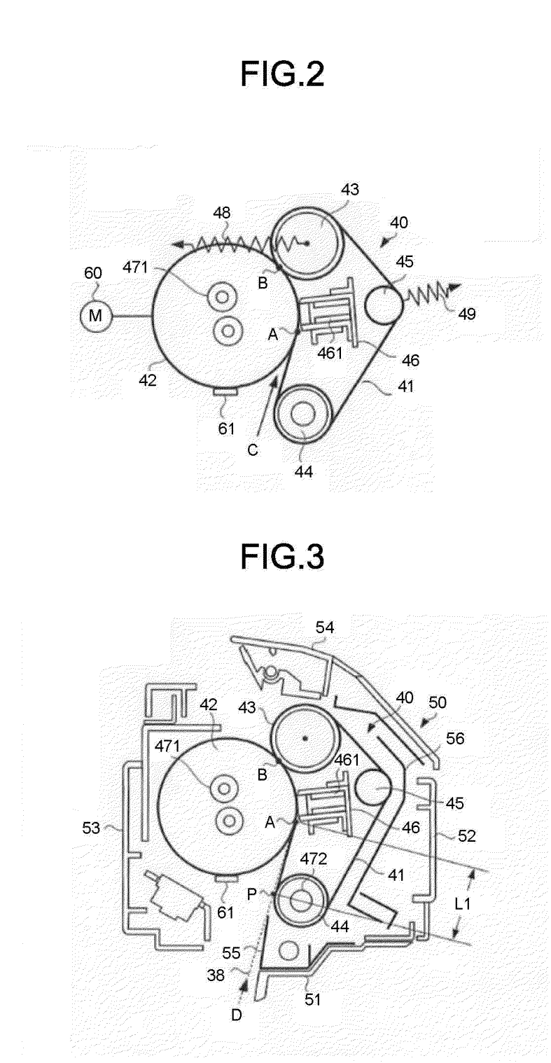

The fixing device 40 is described in detail. FIG. 2 is a constitution diagram illustrating the operations of the fixing device 40. As shown in FIG. 2, the fixing device 40 comprises a fixing belt 41, a heating roller 42, a pressing roller 43, an auxiliary roller 44 and a tension roller 45. The paper S is conveyed and enters the fixing device 40 in a direction indicated by an arrow C. The auxiliary roller 44 is arranged at the entering side of the paper S, and the fixing belt 41 stretched by the pressing roller 43, the auxiliary roller 44 and the tension roller 45 rotates cyclically in a state of being contacted with part of the outer periphery of the heating roller 42.

Further, the fixing device 40 includes a pad member 46, halogen lamps 471 and 472 for heating, a pressing spring 48, and a spring 49 for applying tension. The pressing roller 43 presses, across the fixing belt 41, against the heating roller 42 at a given pressure through the pressing spring 48. The tension roller 45 applies a given tension to the fixing belt through the spring 49. The distance from a point A (hereinafter referred to as first nip point A) where the contact between the fixing belt 41 and the heating roller 42 starts to a point B (hereinafter referred to as second nip point B) where the pressing roller 43 presses the heating roller 42 is referred to as a fixing nip section. The pad member 46 is arranged between the pressing roller 43 and the auxiliary roller 44, and the tension roller 45 is arranged at a position facing the pad member 46.

The fixing nip section is formed by pressing and winding the fixing belt 41 on heating roller 42 through the pressing roller 43 and the pad member 46. The pad member 46 presses against the heating roller 42 through a pressing spring 461. The fixing nip section may also be formed by winding the fixing belt 41 on heating roller 42 through the auxiliary roller 44 instead of the pad member 46. When the paper S passes through the fixing nip section, the toner on the paper S is fixed through heat and pressure. The heating roller 42 is rotated under the driving force transmitted from a DC brushless motor 60 fixed in the printer section 10.

The fixing belt 41, the pressing roller 43, the auxiliary roller 44 and the tension roller 45 are driven to rotate under the rotation of the heating roller 42. Further, the fixing belt 41 is pressed against the heating roller 42 by the pad member 46. The heating roller 42 is formed by coating, for example, PTFE (Polytetrafluoroethylene) on the surface of an iron hollow cylinder.

The heating roller 42, which includes the halogen lamp 471 inside, heats the fixing belt 41 through radiant heat from the halogen lamp 471 inside. Further, the auxiliary roller 44 includes the halogen lamp 472 inside. If the fixing belt 41 is driven to rotate by the rotation of the heating roller 42, the pressing roller 43, the auxiliary roller 44 and the tension roller 45 are rotated by the fixing belt 41, and the temperature variations in the circumferential direction of the heating roller 42 are reduced.

Further, a thermistor 61 for detecting temperature is arranged to be contacted with the surface of the heating roller 42. The halogen lamp 471 is turned on or turned off based on the output of the thermistor 61 to control the surface of the heating roller 42 to reach a given temperature.

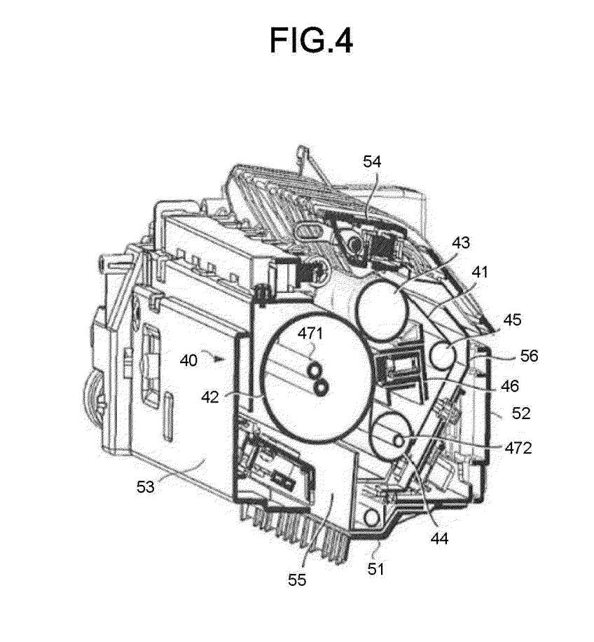

FIG. 3 is a front view illustrating the fixing device 40 and the mechanisms around the fixing device 40. Further, FIG. 4 is a perspective view illustrating the fixing device 40 and the mechanisms around the fixing device 40.

In FIG. 3 and FIG. 4, the fixing device 40 is surrounded by a cover 50. The cover 50 includes a lower cover 51, side covers 52 and 53, and an upper cover 54. An inlet guide 55 for guiding the paper S into the nip section between the heating roller 42 and the pressing roller 43 is fixed at the lower cover 51. An inner cover 56 is arranged around the fixing belt 41.

As shown in FIG. 3, the auxiliary roller 44 is arranged at a position which is closer to the entering side of the paper S than the fixing nip section and is at a preset distance L1 away from the fixing nip section. The distance L1 starting from a point (P) of the auxiliary roller 44 nearest to the conveyance path 38 is a distance from the point (P) to the nip point A of the fixing belt 41.

Further, the inlet guide 55 is arranged at a position which is at the lower side (entering side of the paper S) of the nip point A and is closer to the entering side of the paper S than the auxiliary roller 44. The conveyed paper, after passing through the inlet guide 55, is conveyed by the fixing belt 41 and guided to the nip point A. The paper S conveyed by the fixing belt 41 is heated during the distance L1 through the fixing belt 41 and the auxiliary roller 44. Further, as shown by one dotted lines D in FIG. 3, the front end of the paper conveyed through the inlet guide 55 is directly guided to the fixing nip section rather than through the fixing belt 41.

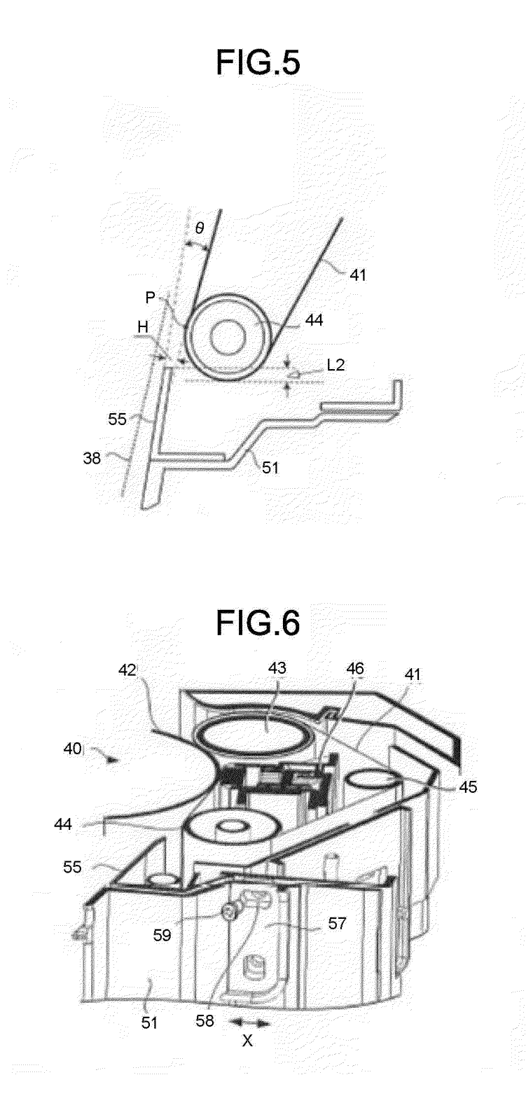

FIG. 5 is an illustration diagram illustrating the position relation between the inlet guide 55 and the auxiliary roller 44. In order to increase the transfer of heat, the inlet guide 55 and the fixing belt 41 are configured in such a manner that the distance L1 becomes longer. That is, part of the fringe of the auxiliary roller 44 is positioned closer to the lower cover 51 (entering side of the paper S) than the front end part of the inlet guide 55 so that the front end part of the inlet guide 55 overlaps with the fringe part of the fixing belt 41 at the entering side of the paper S. The overlap distance is represented by L2. In addition, it is set that the front end part of the inlet guide 55 is not upper than the point (P) of the auxiliary roller 44 nearest to the conveyance path 38.

Further, it is preferred that the part of the fixing belt 41 extending from the auxiliary roller 44 to the fixing nip section is substantially parallel to and is on the same straight line with the surface of the inlet guide 55. However, to avoid paper jam when passing paper from the inlet guide 55 to the fixing belt 41, the inlet guide 55 is not completely parallel to the fixing belt 41, and the surface of the inlet guide 55 has a spread angle θ smaller than 30 degrees at the side of the heating roller 42 with respect to the fixing belt 41.

FIG. 6 is a perspective view illustrating a mounted state of the inlet guide 55 and the lower cover 51. As shown in FIG. 6, the inlet guide 55 is mounted on a fixing section 57 of the lower cover 51. The fixing section 57 has a long hole 58 into which a screw 59 is inserted to fix the inlet guide 55 on the lower cover 51. Thus, the inlet guide 55 can be moved and adjusted within a range equal to the length of the long hole 58 in a direction indicated by an arrow X.

By moving the inlet guide 55, as shown in FIG. 5, the surface of the inlet guide 55 is shifted towards the paper conveyance path 38 with respect to the fixing belt 41, in this way, the front end of the inlet guide 55 is positioned between the paper conveyance path 38 and the fixing belt 41. Thus, a difference in level H between the fixing belt 41 and the inlet guide 55 can be arranged, in this way, even curved paper can be smoothly conveyed without causing paper jam.

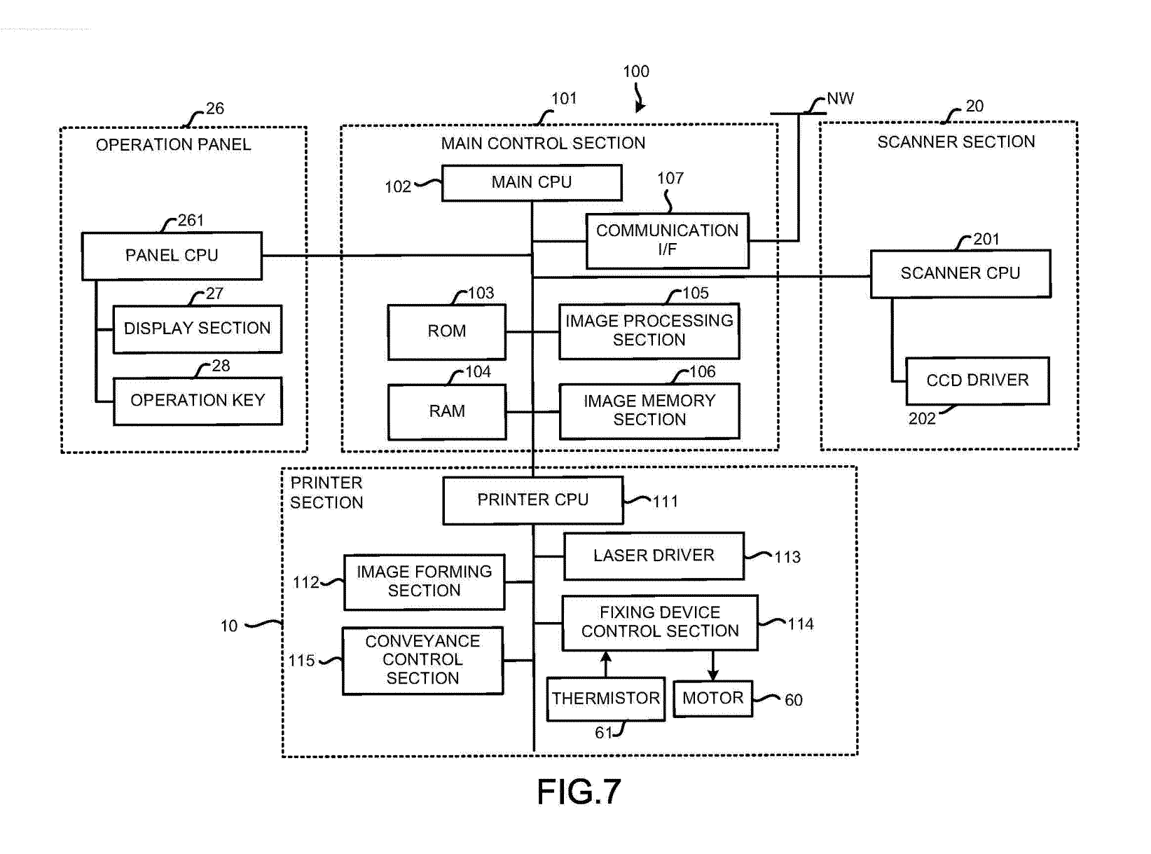

FIG. 7 is a block diagram illustrating the control system of the image forming apparatus 100 according to the embodiment. In FIG. 7, the image forming apparatus 100 comprises a main control section 101, the operation panel 26, the scanner section 20 and the printer section 10. The control system of the image forming apparatus 100 includes a plurality of CPUs, that is, a main CPU 102 in the main control section 101, a panel CPU 261 of the operation panel 26, a scanner CPU 201 of the scanner section 20 and a printer CPU 111 of the printer section 10, and carries out communication between each CPU.

The main control section 101 includes the main CPU 102, a ROM 103, a RAM 104, an image processing section 105, an image memory section 106 such as a HDD, and a communication interface (I/F) 107 and the like. The main CPU 102 controls the whole operations of the image forming apparatus 100. The ROM 103 stores a control program and the like. The RAM 104 temporarily stores data used or generated when the CPU 102 carries out various processing.

The image processing section 105 processes the image data read by the scanner section 20 and the image data from a PC and the like, and carries out various image processing, for example, image conversion processing for enlarging/reducing the image. Further, the image memory section 106 compresses and stores the image data read by the scanner section 20 and the image data (document data, drawn image data and the like) from the PC. The image data stored in the image memory section 106 is input to the image processing section 105, subjected to various image processing and then printed on paper by the printer section 10.

The operation panel 26 includes the panel CPU 261 connected with the main CPU 102, the display section 27 including liquid crystal and the like, and various operation keys 28. The display section 27 has a touch panel function for inputting instructions such as the paper size, printing magnification, simplex printing and duplex printing, and the operation keys 28 include numeric key and the like for carrying out instruction of the number of printings and the like. Further, an erasing mode for erasing the image printed with the erasable coloring agent can be designated by touching the display section 27.

The scanner section 20 includes a CCD driver 202 for driving the image sensor. The CCD driver 202 drives the image sensor to read the image of the original and convert the image into image data.

The printer section 10 includes the printer CPU 111, an image forming section 112, a laser driver 113 for driving the laser of the exposure unit 13, a fixing device control section 114 for controlling the fixing device 40 and a conveyance control section 115 for controlling the conveyance of the paper S. The printer section 10 carries out printing on the paper through cooperation with the main control section 101.

The printer CPU 111 controls the image forming section 112. The image forming section 112 controls the photoconductive drum 11, the electrostatic charger 12, the developer 14 and the transfer roller 15 and the like to form an image.

The fixing device control section 114 controls the rotation of the motor 60 which drives the heating roller 42. Further, the fixing device control section 114, which is connected with the thermistor 61, controls the temperature of the halogen lamp 471 according to the temperature detection result of the thermistor 61 to control the temperature of the fixing device 40 according to the fixing processing and the erasing processing. In a case of fixing the toner image formed with the erasable coloring agent on the paper S, the fixing device 40 heats the paper S at a temperature of, for example, about 90˜100 degrees centigrade. Further, in a case of erasing the image formed on the paper S, the fixing device 40 controls to heat the paper S at a temperature of, for example, about 120 degrees centigrade.

Moreover, to enable the selection of the printing mode and the erasing mode through the operation panel 26, for example, a “print” button and an “erase” button for selecting mode are set and displayed on the display section 27. A user can touch either of buttons to select a mode.

For example, if the “print” button is touched, the image forming section 10 forms an image on the paper S and the fixing device 40 heats the paper S at a temperature of, for example, about 90˜100 degrees centigrade to fix the image on the paper S. Further, if the “erase” button is touched, the fixing device 40 heats the paper S at a temperature of, for example, about 120 degrees centigrade to erase the image formed on the paper S. The paper can be reused after the image is erased.

The conveyance control section 115 controls the motor (not shown) for driving the transfer roller 15, the register roller 34, the paper discharge roller 36 and the like based on the control of the printer CPU 111 to control the conveyance of the paper.

In the embodiment described above, the paper S is heated in advance during the distance L1 through the auxiliary roller 44 and the fixing belt 41, thus, in a case of erasing the images formed on both sides of the paper S, sufficient heat can be applied to the paper, and therefore, the images can be completely erased.

In addition, the present invention is not limited to the embodiment described above, and the present invention can be applied to various applications. For example, it may be applied to a quadruple tandem type image forming apparatus having a plurality of developing units for different colors. Further, a scanning head including a LED element may be used instead of the exposure unit 13 having a laser light source.

Furthermore, though it is exemplified that the printer section 10 controls the fixing device 40 through the fixing device control section 114, and controls the conveyance of the paper through the conveyance control section 115, the present invention is not limited to this, and the fixing device 40 and the conveyance of the paper may be controlled through one single control section (for example, the main CPU 102 or the printer CPU 111).

While certain embodiments have been described, these embodiments have been presented by way of example only, and are not intended to limit the scope of the invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

1-10. (canceled)

11. An image forming apparatus comprising:
an image forming section configured to be capable of forming an image with erasable coloring agent;
a fixing device arranged at a downstream side of the image forming section, which fixes an image formed by the image forming section on an image receiving medium, configured to include a heating roller, a pressing roller arranged at a position facing the heating roller, an auxiliary roller provided with a heating element inside and arranged at an entering side of the image receiving medium, and a fixing belt which is stretched by a plurality of rollers including the pressing roller and the auxiliary roller and is contacted with the outer periphery of the heating roller; wherein the auxiliary roller is arranged at a position which is closer to the entering side of the image receiving medium than a fixing nip section between the heating roller and the fixing belt and is at a preset distance away from the fixing nip section;
an inlet guide configured closer to the entering side of the image receiving medium of upstream than the heating element of the auxiliary roller to guide the image receiving medium towards the fixing nip section, wherein a front end part of the inlet guide at the fixing device side overlaps with a fringe part of the auxiliary roller at a entering side of the image receiving medium, and provided a difference the front end of the inlet guide and the fixing belt; and
a control section configured to control the temperature of the fixing device in a first temperature range in a case of fixing the image formed by the image forming section on the image receiving medium, and control the temperature of the fixing device in a second temperature range higher than the first temperature range in a case of erasing the image formed on the image receiving medium with the erasable coloring agent.

12. The image forming apparatus according to claim 11, further comprising:
an operation panel through which a first mode for operating the fixing device in the first temperature range and a second mode for operating the fixing device in the second temperature range can be selected.

13. The image forming apparatus according to claim 11, wherein
the fixing device includes the pressing roller arranged at a position facing the heating roller and stretches the fixing belt among a plurality of rollers including the pressing roller and the auxiliary roller.

14. The image forming apparatus according to claim 13, wherein
the fixing device includes, between the pressing roller and the auxiliary roller, a pad member for pressing the fixing belt against the heating roller.

15. The image forming apparatus according to claim 11, wherein
the fixing belt extending between the auxiliary roller and the fixing nip section is substantial parallel to the inlet guide, and conveys the image receiving medium to the fixing nip section along the surface of the inlet guide.

16. The image forming apparatus according to claim 15, wherein
the front end of the inlet guide is positioned between the conveyance path of the image receiving medium and the fixing belt of the fixing device.

17. The image forming apparatus according to claim 11, wherein
the surface of the inlet guide is shifted towards the conveyance path of the image receiving medium with respect to the fixing belt extending between the auxiliary roller and the fixing nip section, and the image receiving medium is conveyed to the fixing nip section along the surface of the inlet guide.

18. (canceled)

19. The image forming apparatus according to claim 17, wherein
the surface of the inlet guide has a given spread angle at the side of the heating roller with respect to the fixing belt extending between the auxiliary roller and the fixing nip section.

20. The image forming apparatus according to claim 11, wherein
the heating roller and the auxiliary roller of the fixing device are provided with a heating lamp inside, respectively.
